(19) United States
(12) Patent Application Publication
(10) Pub. No.: US 2010/0216029 A1
(43) Pub. Date: Aug. 26, 2010

(54) Lithium Ion Secondary Battery

(75) Inventor: NORIO IWAYASU, HITACHINAKA (JP)

Correspondence Address: CROWELL & MORING LLP;INTELLECTUAL PROPERTY GROUP, P.O. BOX 14300, WASHINGTON, DC, 20044-4300, US

(73) Assignee: HITACHI, LTD., CHIYODA-KU (JP)

(21) Appl. No.: 12/694,683

(22) Filed: Jan. 27, 2010

(30) Foreign Application Priority Data
Feb. 25, 2009 (JP) 2009-041640

(51) Int. Cl. H01M 6/18

(52) U.S. Cl. 429/304

(57) ABSTRACT

An overcharge suppressing agent adapted to react when the positive electrode potential becomes higher, to increase the internal resistance of a battery during overcharge in an lithium ion secondary battery in which a positive electrode capable of occluding and releasing lithium and a negative electrode capable of occluding and releasing lithium are formed by way of an electrolyte. The electrolyte contains a polymerizable compound represented by the chemical formula (1-1) or the chemical formula (1-2):

Z₁-A Chemical formula (1-1)

Z₁-X-A Chemical formula (1-2)

in which Z₁ is a polymerizable functional group, X is a hydrocarbon group or an oxyalkylene group having 1 or more and 20 or less carbon atoms, and A is an aromatic functional group.

### BACKGROUND OF THE INVENTION

1. Field of the Invention

The present invention relates to a lithium ion secondary battery high in safety.

2. Description of the Related Art

A lithium ion secondary battery has a high energy density and has been utilized generally, for example, in laptop personal computers or cellular phones while taking advantage of its characteristics. In recent years, electric cars have attracted attention with a view point of prevention of global warming caused by increase in carbon dioxide emission, and the application of the lithium ion battery to electric cars as their electric power source has been studied.

Although the lithium ion battery has such excellent characteristics, it also involves problems. One of the problems is related to improvement in safety. In particular, it is an important subject to ensure safety during overcharge.

If the lithium battery is overcharged, then the thermal stability of the battery will deteriorate and its safety may be lowered. To cope with this, a control circuit is provided for detecting the overcharging state and stopping charging on current lithium ion batteries, thereby ensuring the safety. The overcharging state is detected by monitoring the battery voltage. However, the difference between an operation voltage of a battery and a voltage in the overcharging state thereof is small and so it was difficult to properly detect the overcharge state by use of the control circuit. Further, in case the control circuit fails, since overcharging may occur, it is important to secure the safety of the lithium ion battery itself during overcharge.

JP-A-2003-22838 describes that suppression of overcharge is achieved by having cyclohexylbenzene or biphenyl dissolved in an electrolyte so as to ensure the safety of the lithium ion battery itself during overcharge.

Further, JP-A-1997-106835 also proposes a technique that suppresses overcharge by having thiophene dissolved in the electrolyte. In this technique, cyclohexylbenzene, etc. are electrolytically polymerized on a positive electrode put to a high potential upon overcharge, thereby consuming a charging current and suppressing the charging reaction of the battery. However, when cyclohexylbenzene is electrolytically polymerized completely, the charging reaction of the battery will start again. In this case, if the electrolytic polymerization product of cyclohexylbenzene has an effect of increasing the internal resistance of the battery, it is possible to suppress the overcharge. Unfortunately, the electrolytic polymerization product of cyclohexylbenzene has less effect of increasing the internal resistance.

Further, since thiophene has low electrochemical stability and tends to cause decomposition in the inside of the battery, the battery performance may deteriorate.

Accordingly, it has been strongly demanded to develop an overcharge suppressing agent which increases the internal resistance of the battery when it is put to an overcharged state, without reacting within an operation voltage range of a battery, thereby shutting down the voltage reaction. Further, overvoltage is increased when the internal resistance increases during overcharge, so the charging state may be detected appropriately. Accordingly, if such an overcharge suppressing agent is applied, the effect thereof is significant also in terms of control on the battery.

### SUMMARY OF THE INVENTION

Then, as a result of intensive study, the present inventors provide an overcharge suppressing agent adapted to react when the positive electrode potential is increased upon overcharge to increase the internal resistance of a battery. Further, the overcharge suppressing agent has high electrochemical stability within the operation voltage range of the battery and can be used without deterioration of the battery performance.

In a lithium ion secondary battery of the invention, a positive electrode and a negative electrode capable of occluding and releasing lithium are formed by way of an electrolyte in which a polymerizable compound represented by the chemical formula (1-1) or the chemical formula (1-2) is contained.

When the overvoltage suppressing agent according to the invention is used, this increases the internal resistance of the lithium ion secondary battery during overcharge and suppresses the overcharge. Further, since overvoltage increases when the internal resistance increases during overcharge, the charged state can be detected properly. Further, the overcharge suppressing agent has high electrochemical stability within the operation voltage range of the battery and can be used without deteriorating the battery performance.

Thus, a lithium ion battery high in safety during overcharge can be provided.

### BRIEF DESCRIPTION OF THE DRAWING

Other objects and advantages of the invention will become apparent from the following description of embodiments with reference to the accompanying drawings in which:

FIG. 1 is a graph showing a relation between the amount of overcharge and a battery voltage during overcharge.

FIGS. 2 and 3 are a view showing a lithium ion secondary battery.

### DESCRIPTION OF THE PREFERRED EMBODIMENTS

Features of an embodiment according to the present invention are to be described below.

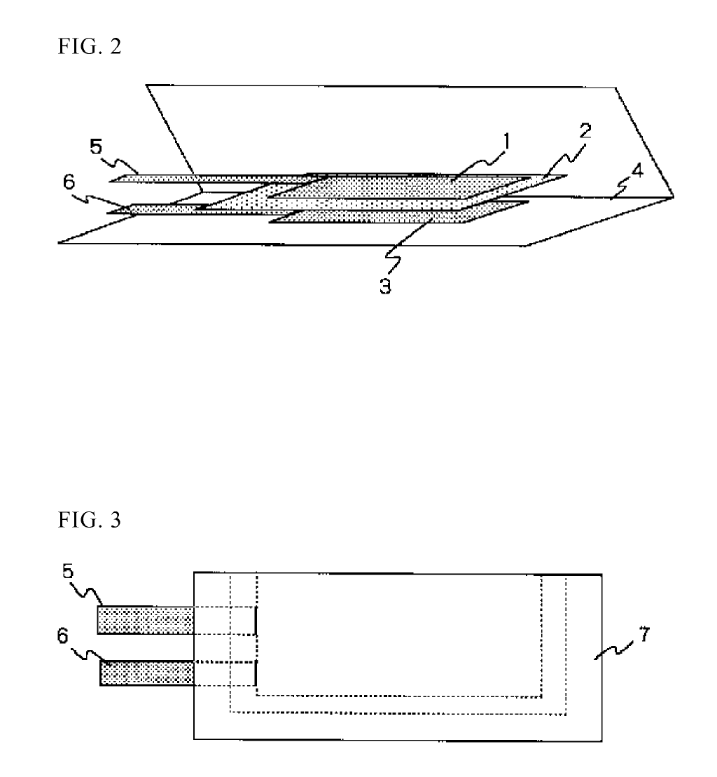

FIGS. 2 and 3 show a schematic cross section of a lithium ion secondary battery. The electrodes and nonaqueous electrolyte are sealed in a battery case. In the lithium secondary battery, a separator 2 is interposed between a positive electrode 1 and a negative electrode 3. A positive lead 5 is connected to the positive electrode 1, and a negative lead 6 is connected to the positive electrode 3. These positive electrode 1, negative electrode 3, and separator 2 are enclosed together with a nonaqueous electrolyte into a bag made of laminated aluminum 4. A lithium ion secondary battery according to the example of the invention is a lithium ion secondary battery in which a positive electrode capable of occluding and releasing lithium and a negative electrode capable of occluding and releasing lithium are formed by way of an electrolyte, wherein the electrolyte contains a polymerizable compound represented by the chemical formula (1-1) or the chemical formula (1-2):

Z₁-A Chemical formula (1-1)

Z₁-X-A Chemical formula (1-2)

in which Z₁ is a polymerizable functional group, X is a hydrocarbon group or an oxyalkylene group having 1 or more and 20 or fewer carbon atoms, and A is an aromatic functional group. A polymerizable compound polymerizes each other with the polymerizable functional group. Additionally, during overpotential, the coupling reaction is occurred between the aromatic compounds groups, like aryl group, and a high resistance (or insulate) layer appears on positive electrode. As a consequence, the overcharge of the battery is suppressed. Further, the electrolyte contains a polymer obtained by polymerizing the polymerizable compound, and the number average molecular weight (Mn) of the polymer is 1,000,000 or less.

Further, the polymer comprises a polymer represented by the chemical formula (2-1) or the chemical formula (2-2):

Zₚ₁-A Chemical formula (2-1)

Zₚ₁-X-A Chemical formula (2-2)

in which Z_{P1} is an organic group formed by polymerizing polymerizable functional groups, X is a hydrocarbon group or an oxyalkylene group having 1 or more and 20 or fewer carbon atoms, and A is an aromatic functional group.

Further, the lithium ion secondary battery according to an embodiment of the invention is such that a positive electrode capable of occluding and releasing lithium and a negative electrode capable of occluding and releasing lithium are formed by way of an electrolyte, and has one or more polymerizable compounds selected from the group consisting of polymerizable compounds represented by the chemical formula (1-1) or the chemical formula (1-2), and one or more polymerizable compounds selected from the group consisting of polymerizable compounds represented by chemical formula (3):

Z₁-A Chemical formula (1-1)

Z₁-X₁-A Chemical formula (1-2)

Z₂-Y Chemical formula (3)

in which Z₁ is a polymerizable functional group, X is a hydrocarbon group or an oxyalkylene group having 1 or more and 20 or fewer carbon atoms, A is an aromatic functional group, Z₂ is a polymerizable functional group, Y is a functional group comprising at least one element selected from H, C, N, O, F, S, and Si. The compounds represented by chemical formula 3 are inserted in polymer for making high affinity for nonaqueous electrolyte.

Further, the electrolyte contains a polymer obtained by copolymerizing one or more polymerizable compounds selected from the group consisting of polymerizable compounds represented by the chemical formula (1-1) or the chemical formula (1-2), one or more polymerizable compounds selected from the group consisting of the polymerizable compound represented by the formula (3).

Further, the polymer contains a polymer comprising a repetitive unit represented by the chemical formula (4-1) or the chemical formula (4-2):

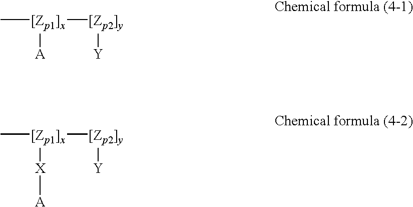

in which Zₚ₁ is an organic group formed by polymerizing polymerizable functional groups, X is a hydrocarbon group or an oxyalkylene group having 1 or more and 20 or fewer carbon atoms, A is an aromatic functional group, Zₚ₂ is an organic group formed by polymerizing a polymerizable functional groups, Y is a functional group comprising H, C, N, O, F, S, and Si, and x and y show the ratio of the constituent units for Z₁ and Z₂.

Further, the chemical formula (4-1) or the chemical formula (4-2) satisfies a relation: 0.1×/(x+y) 0.9.

Further, the polymer is represented by the chemical formula (5):

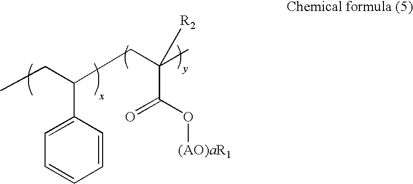

in which AO is an oxyalkylene group having 1 or more and 4 or fewer carbon atoms, a is a number for the oxyalkylene group, and each of R₁ and R₂ is H or hydrocarbon group having 1 or more and 20 or fewer carbon atoms.

Further, the lithium ion secondary battery of an embodiment of the invention is such that a positive electrode capable of occluding and releasing lithium and a negative electrode capable of occluding and releasing lithium are formed by way of an electrolyte, wherein the electrolyte contains a polymerizable compound represented by the chemical formula (1-1) or the chemical formula (1-2), and the polymerizable compound is polymerized at 2.0 V or higher on the basis of Li/Li+. The polymerizable compound is preferably polymerized at 4.5 V or higher on the basis of Li/Li+.

The increasing rate of the overvoltage at the potential of about 5.1 V is 0.2 Vcm²/mAh or higher.

Preferred embodiments of the present invention are to be described specifically.

In the chemical formula (1-1) or the chemical formula (1-2) according to the embodiment of the invention, Z₁ is a polymerizable functional group and X is a hydrocarbon group or an oxyalkylene group having 1 to 20 carbon atoms. A is an aromatic functional group.

The polymerizable functional group is not particularly restricted so long as this causes polymerizing reaction, and organic groups having an unsaturated double bound, for example, vinyl group, acryloyl group, or methacryloyl group can be used suitably. The hydrocarbon group having 1 to 20 carbon atoms includes, for example, aliphatic hydrocarbon groups such as a methylene group, ethylene group, propylene group, isopropylene group, butylene group, isobutylene group, dimethylethylene group, pentylene group, hexylene group, heptylene group, octylene group, isooctylene group, decylene group, undecylene group, and dodecylene group, and cycloaliphatic hydrocarbon groups such as cyclohexylene group, and dimethyl cyclohexylene group. The oxyalkylene group includes an oxymethylene group, oxyethylene group, oxypropylene group, oxybutylene group, and oxytetramethylene group. The aromatic functional group is a functional group having 20 or fewer carbon atoms and satisfying Huckel's rule. Specifically, the functional aromatic group includes phenyl group and condensated bodies of phenyl group such as naphthyl group, anthryl group, phenanthryl group, triphenylene group, pyrene group, chrysene group, naphthacene group, picene group, perylene group, pentaphene group, penthacene group, and acenaphthylene group. A portion of such aromatic functional groups may be substituted. Further, the aromatic functional group may also contain other elements exclusive of carbon in the aromatic ring. Specifically, they are elements such as S, N, Si, and O. With a view point of the electrochemical stability, the phenyl group, the naphthyl group, and the anthracene group are preferred and the phenyl group is particularly preferred.

The polymer according to the invention is a compound obtained by polymerizing the polymerizable compound. Both the polymerizable compound and the polymer can be used and, with a view point of the electrochemical stability, it is preferred to use a polymer formed by previously polymerizing the polymerizable compound to prepare a polymer and then purifying the same.

Polymerization may be conducted by any of bulk polymerization, solution polymerization, and emulsion polymerization known so far. Further, while the polymerizing method is not particularly restricted, radical polymerization is used suitably. Upon polymerization, a polymerization initiator may or may not be used and a radical polymerization initiator is used preferably with a view point of easy handling. The polymerizing method using the radial polymerization initiator can be conducted within a temperature range and for a polymerization time employed usually. With a purpose of not deteriorating a member used for an electrochemical device, it is preferred to use a radical polymerization initiator having a 10 hours half-life temperature range of 30 to 90° C. as an index for the decomposing temperature and velocity. The 10 hour half-life temperature means a temperature that is necessary for decreasing the amount of the not decomposed radical polymerization initiator to one-half in 10 hours, at a concentration of 0.01 mol/L in a radical inert solvent such as benzene. The amount of blending the initiator in the invention is from 0.1 wt % to 20 wt % and, preferably, 0.3 wt % or more and 5 wt % or less of the polymerizable compound's weight. The radical polymerization initiator includes organic peroxides such as t-butylperoxy pivalate, t-hexylperoxy pivalate, methyl ethyl ketone peroxide, cyclohexanone peroxide, 1,1-bis(t-butylperoxy)-3,3,5-trimethyl cyclohexane, 2,2-bis(t-buthylperoxy)octane, n-butyl-4,4-bis(t-butylperoxy)valerate, t-butyl hydroperoxide, cumene hydroperoxide, 2,5-dimethylhexane-2,5-dihydroperoxide, di-t-butyl peroxide, t-butylcumyl peroxide, dicumyl peroxide, α,α′-bis(t-butylperoxy m-isopropyl)benzene, 2,5-dimethyl-2,5-di(t-butylperoxy)hexane, benzoylperoxide, and t-butylperoxypropyl carbonate; and azo compounds such as 2,2′-azobis-isobutyronitrile, 2,2′-azobis(2-methylbutyronitrile), 2,2′-azobis(4-methoxy-2,4-dimethylvaleronitrile), 2,2′-azobis(2,4-dimethylvaleronitrile), 1,1′-azobis(cyclonexane-1-carbonitrile), 2-(carbamoylazo)isobutyronitrile, 2-phenylazo-4-methoxy-2,4-dimethyl-valeronitrile, 2,2-azobis(2-methyl-N-phenylpropionamidine) dihydrogen chloride, 2,2′-azobis[N-(4-chlorophenyl)-2-methylpropionamidine]dihydrogen chloride, 2,2′-azobis[N-hydroxyphenyl]-2-methylpropionamidine]dihydrogen chloride, 2,2′-azobis[2-methyl-N-(phenylmethyl)propionamidine]dihydrogen chloride, 2,2′-azobis[2-methyl-N-(2-propenyl)propionamidine]dihydrogen chloride, 2,2′-azobis(2-methylpropionamidine) dihydrogen chloride, 2,2′-azobis[N-(2-hydroxyethyl)-2-methylpropionamidine]dihydrogen chloride, 2,2′-azobis[2-(5-methyl-2-imidazolin-2-yl)propane]dihydrogen chloride, 2,2′-azobis[2-(2-imidazolin-2-yl)propane]dihydrogen chloride, 2,2′-azobis[2-(4,5,6,7-tetrahydro-1H-1,3-diazepin-2-yl)propane]dihydrogen chloride, 2,2′-azobis[2-(3,4,5,6-tetrahydropyrimidin-2-yl)propane]dihydrogen chloride, 2,2′-azobis[2-(5-hydroxy-3,4,5,6-tetrahydropyrimidin-2-yl)propane]dihydrogen chloride, 2,2′-azobis{2-[1-(2-hydroxyethyl)-2-imidazolin-2-yl]propanel}dihydrogen chloride, 2,2′-azobis[2-(2-imidazolin-2-yl)propane], 2,2′-azobis{2-methyl-N-[1,1-bis(hydroxymethyl)-2-hydroxyethyl]propionamide}, 2,2′-azibus{2-methyl-N-[1,1-bis(hydroxymethyl)ethyl]propionamide}, 2,2′-azobis[2-methyl-N-(2-hydroxyethyl)propionamide], 2,2′-azobis(2-methylpropionamide)dihydrate, 2,2′-azobis(2,4,4-trimethylpentane), 2,2′-azobis(2-methylpropane), 2,2′-azobisisobutyrate, 4,4′-azobis(4-cyanovalerate), and 2,2′-azobis[2-(hydroxymethyl)propionitrile].

Zₚ₁ in the chemical formula (2-1) or the chemical formula (2-2) of the invention is an organic group formed by polymerizing the polymerizable functional group. X is a hydrocarbon group or an oxyalkylene group having 1 or more and 20 or fewer carbon atoms. X may or may not be present and A is bonded directly to Z where X is not present. A is an aromatic functional group. The hydrocarbon group having 1 or more and 20 or fewer carbon atoms includes, for example, aliphatic hydrocarbon groups such as methylene group, ethylene group, propylene group, isopropylene group, butylenes group, isobutylene group, dimethylethylene group, pentylene group, hexylene group, heptylene group, octylene group, isooctylene group, decylene group, undecylene group, and dodecylene group, and cycloaliphatic hydrocarbon groups such as cyclohexylene group, and dimethyl cyclohexylene group. The oxyalkylene group includes oxymethylene group, oxyethylene group, oxypropylene group, oxybutylene group, and oxytetramethylene group. The aromatic functional group is a functional group having 20 or fewer carbon atoms and satisfying the Huckel's rule. Specifically, the functional group includes phenyl group or condensed bodies of phenyl group such as naphthyl group, anthryl group, phenanthryl group, triphenylene group, pyrene group, chrysene group, naphthacene group, picene group, perylene group, penthaphene group, penthacene group, and acenaphthylene group. A portion of the aromatic functional groups may be substituted. Further, the aromatic functional group may also contain other elements exclusive of carbon in the aromatic ring. Specifically, they are elements such as S, N, Si, and O. With a view point of electrochemical stability, the phenyl group, the naphthyl group, and the anthracene group are preferred and the phenyl group is particularly preferred.

Z₂ in the chemical formula (3) of the invention is a polymerizable functional group. The functional group is not particularly restricted so long as this causes the polymerizing reaction, and organic groups having a unsaturated double bond such as vinyl group, acryloyl group, or methacryloyl group are used suitably. Y is a functional group comprising H, C, N, O, Cl, Br, F, S, and Si. The existence form of these elements include, for example, linear hydrocarbon group, cyclic hydrocarbon group, oxyalkylene group [(AO)ₘR]carboxyl group, hydroxyl group, amino group, cyano group, sulfonyl group, nitroxyl group, thiocarbonyl group, thionitrocyl group, and halogen. Each portion of the linear hydrocarbon group, the cyclic hydrocarbon group and the oxyalkylene group may be substituted by carboxyl group, hydroxyl group, amino group, cyano group, sulfonyl group, nitroxyl group, thiocarbonyl group, thionitrosyl group, or hydrogen. In the invention, the linear hydrocarbon group, the cyclohydrocarbon group, the cyano group, and the oxyalkylene group are used suitably. Among them, a functional group formed by substituting each portion of the alkylene oxide group and the linear hydrocarbon group by a hydroxyl group is used suitably for enhancing the affinity with a highly polar electrolyte. The alkylene oxide group is preferably those in which AO is an ethylene oxide group and R is methyl, where m is 1 or more and 20 or less, preferably, 1 or more and 10 or less, and, particularly preferably, 1 or more and 5 or less. Affinity with the electrolyte is enhanced by controlling m. The functional group formed by substituting a portion of the linear hydrocarbon group by the hydroxyl group is that formed by substituting a portion of a linear hydrocarbon group having 1 or more and 10 or fewer carbon atoms by the hydroxyl group and it is preferably [CH₂OH]. Alkylene oxide group is particularly preferred.

Each of Zₚ₁ and Zₚ₂ in the chemical formula (4-1) or the chemical formula (4-2) of the invention is an organic group formed by polymerizing the polymerizable functional groups. x and y are ratio for the constituent units of Z₁ and Z₂. x/(x+y) is 0 or more and 1 or less. It is preferably 0.1 or more and 0.9 or less and, particularly preferably, 0.5 or more and 0.85 or less with a view point of high overcharge suppressing effect and for improving the affinity with a highly polar electrolyte.

The form of the polymerizable compound and the polymer of the invention present in a non-aqueous secondary battery is not particularly restricted and it is preferred to be used being present together in the electrolyte.

The state of the polymerizable compound and the polymer present in the electrolyte in this embodiment may be a solution, or it may be used also in a suspended state. The concentration of the polymerizable compound and the polymer [(wt %=(weight of polymerizable compound and polymer)/(weight of electrolyte+weight of polymerizable compound and polymer)×100] is 0% or more and 100% or less, preferably, 0.01% or more and 5% or less and, particularly preferably, 0.1% or more and 3% or less. As the value is larger, the ionic conductivity of the electrolyte is lowered to deteriorate the battery performance. Further, as the value is smaller, the effect of the invention is lowered.

The number average molecular weight (Mn) of the polymer of the invention is 50,000,000 or less and, preferably, 1,000,000 or less. More preferably, it is 100,000 or less. Deterioration of the battery performance can be suppressed by using a polymer of a low number average molecular weight.

The electrolyte of the invention is formed by dissolving a supporting electrolyte in a non-aqueous solvent. The non-aqueous solvent is not particularly restricted so long as it dissolves the supporting electrolyte and those described below are preferred. They are organic solvents such as diethyl carbonate, dimethyl carbonate, ethylene carbonate, ethyl methyl carbonate, propylene carbonate, γ-butyrolactone, tetrahydrofuran, and dimethoxy ethane and they may be used alone or as a mixture of them.

The supporting electrolyte of the invention is not particularly restricted so long as it is soluble to the non-aqueous solvent and those referred to below are preferred. That is, they are electrolyte salts such as LiPF₆, LiN(CF₃SO₂)₂, LiN(C₂F₆SO₂)₂, LiClO₄, LiBF₄, LiAsF₆, LiI, LiBr, LiSCN, Li₂B₁₀Cl₁₀, and LiCF₃CO₂. They may be used alone or one or more of them may be used in admixture.

AO in the chemical formula (5) of the invention is an alkylene oxide group having 1 to 4 carbon atoms in which a is a number of alkylene oxide groups. Each of R₁ and R₂ is H or a hydrocarbon group having 1 or more and 20 or fewer carbon atoms. The alkylene oxide group of AO having 2 to 4 carbon atoms is, specifically, methylene oxide group, propylene oxide group, and butylene group, and the ethylene oxide group is used suitably. In the invention, linear hydrocarbon groups, cyclic hydrocarbon groups, and alkylene oxide groups are used suitably. Among them, functional groups formed by substituting each portion of the alkylene oxide group and the linear hydrocarbon by a hydroxyl group are used suitably since they enhance the affinity with a highly polar electrolyte. Alkylene oxide groups in which AO is ethylene oxide group and R is methyl are preferred in which m is 1 or more and 20 or less, preferably, 1 or more and 10 or less and, particularly preferably, 1 or more and 5 or less. The affinity with the electrolyte is enhanced more by controlling m.

The positive electrode of the invention is those capable of occluding and releasing lithium ions and, for example, oxides having a layered structure such as LiCoO₂, LiNiO₂, LiMn_{1/3}Ni_{1/3}CO_{1/3}O₂, and LiMn_{0.4}Ni_{0.4}Co_{0.2}O₂, Mn oxides having a spinel type crystal structure such as LiMn₂O₄ or Li₁₊ₓMn₂₋ₓO₄, or those formed by substituting a portion of Mn by other elements such as Co or Cr can be used. Further, a positive electrode having an olivine type crystal structure such as LiFePO₄ can also be used.

Further, for the negative electrode of the invention, natural graphite, those formed by heat treating an easily graphitizable material obtained from petroleum coke or coal pitch coke, etc. at a high temperature of 2500° C. or higher, meso-phase carbon or amorphous carbon, carbon fibers, metals capable of alloying with lithium, or materials supporting a metal on the surface of carbon particles are used. For example, they are metals selected from lithium, silver, aluminum, tin, silicon, indium, gallium and magnesium, or alloys thereof. Further, the metals or the oxides of the metals can be utilized as the negative electrode. Further, lithium titanate can also be used.

As the separator of the invention, those comprising polymers such as polyolefin, polyamide, polyester and glass cloth using fibrous glass fibers can be used and the material is not restricted so long as it is a reinforcing material not giving undesired effects on the lithium battery and polyolefin is used suitably.

The polyolefin includes polyethylene, polypropylene, etc. and films of them may be stacked for use.

The air permeability (sec/100 mL) of the separator is 10 or more and 1000 or less, preferably, 50 or more and 800 or less and, particularly preferably, 90 or more and 700 or less.

The overcharge suppressing agent of the invention is those that react at a certain voltage and suppress overcharge. The reaction is taken place at a voltage higher than the operation voltage of the battery. Specifically, this is 2 V or higher on the basis of Li/Li+ and, preferably, 4.5 V or higher. When the value is too small, the overcharge suppressing agent is decomposed in the inside of the battery to deteriorate the battery performance.

The increasing rate of the overvoltage of the invention is decided by determining a difference (V) between the reaction initiation voltage and the upper limit voltage of the overcharge suppressing agent and the amount of charge (mAh) necessary for the difference and defining the ratio (V/mAh). Further, the value is converted per electrode unit area (cm²) (Vcm²/mAh) and normalized the same.

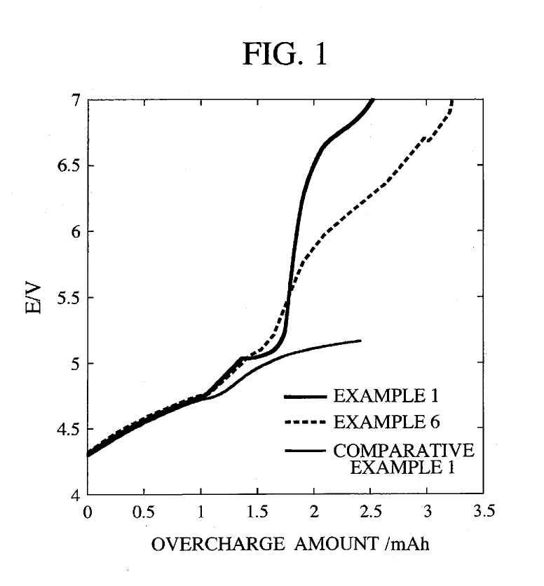

Examples are to be described specifically but the invention is not restricted to the examples. The result of the examples is shown collectively in Table 1. FIG. 1 shows an example of measurement for the amount of overcharge and the battery voltage during overcharge.

TABLE 1

| | | | | | Polymer | | |
|---|---|---|---|---|---|---|---|
| | | | Mol ratio | Name of | concentration | Positive | Negative |
| Example | Formula(1)a | Formula (3) b | a/(a + b) | polymer | Wt % | electrode | electrode |
| 1 | Styrene | Diethylene glycol mono- | 0.75 | Polymer A | 2 | LiCoO₂ | Li metal |
| | | methyl ether methacrylate | | | | | |
| 2 | Styrene | Diethylene glycol mono- | 0.75 | Polymer A | 5 | LiCoO₂ | Li metal |
| | | methyl ether methacrylate | | | | | |
| 3 | Styrene | Diethylene glycol mono- | 0.75 | Polymer A | 10 | LiCoO₂ | Li metal |
| | | methyl ether methacrylate | | | | | |
| 4 | Styrene | Diethyleneglycol mono- | 0.05 | Polymer B | 2 | LiCoO₂ | Li metal |
| | | methyl ether methacrylate | | | | | |
| 5 | Styrene | Diethylene glycol mono- | 0 | Polymer C | 2 | LiCoO₂ | Li metal |
| | | methyl ether methacrylate | | | | | |
| 6 | Styrene | Allyl alcohol | 0.4 | Polymer D | 2 | LiCoO₂ | Li metal |
| 7 | Styrene | Allyl alcohol | 0.75 | Polymer E | 2 | LiCoO₂ | Li metal |
| 8 | Styrene | Acrylonitrile | 0.75 | Polymer F | 2 | LiCoO₂ | Li metal |
| 9 | Styrene | Diethylene glycol mono- | 0.75 | Polymer A | 2 | LiCoO₂ | Amorphous |
| | | methyl ether methacrylate | | | | | carbon |
| 10 | Styrene | — | 1 | Polymer G | 2 | LiCoO₂ | Li metal |
| 11 | Phenyl | Diethylene glycol mono- | 0.75 | Polymer H | 2 | LiCoO₂ | Li metal |
| | methacrylate | methyl ether methacrylate | | | | | |
| 12 | Styrene | Diethylene glycol mono- | 0.75 | Monomer | 2 | LiCoO₂ | Li metal |
| | | methyl ether methacrylate | | composition A | | | |
| 13 | Styrene | — | 1 | Monomer | 2 | LiCoO₂ | Li metal |
| | | | | composition B | | | |

| Comparative | | | | Concentration/ | Positive | Negative |
|---|---|---|---|---|---|---|
| Example | | | | wt % | electrode | electrode |
| 1 | Cyclohexyl benzene | — | — | 2 | LiCoO₂ | Li metal |
| 2 | Cyclohexyl benzene | — | — | 2 | LiCoO₂ | Amorphous |
| | | | | | | carbon |
| 3 | Thiophene | — | — | 2 | LiCoO₂ | Li metal |
| 4 | Only electrolyte | — | — | — | LiCoO₂ | Li metal |
| 5 | Only electrolyte | — | — | — | LiCoO₂ | Amorphous |
| | | | | | | carbon |

| | | | | | | Increasing | |
|---|---|---|---|---|---|---|---|
| | Battery | DC resistance | Cycle | Reaction | Increase | velocity | DC resistance |
| | capacity/ | (before | character- | initiation | of over- | V/mAh | (after |
| | mAh | overcharge) | istic | voltage/V | voltage | (Vcm2/mAh) | overcharge) |
| Example | | | | | | | |
| 1 | 2.4 | 10 | 0.98 | 5.1 | ∘ | 2.0(3.5) | 31 |
| 2 | 2.2 | 14 | 0.95 | 5.1 | ∘ | 2.5(4.4) | 42 |
| 3 | 2 | 20 | 0.95 | 5.1 | ∘ | 2.3(4.1) | 54 |
| 4 | 2.4 | 13 | 0.98 | — | x | — | — |
| 5 | 2.2 | 16 | 0.9 | — | x | — | — |
| 6 | 2.3 | 26 | 0.9 | 4.8 | ∘ | 0.80(1.4) | 42 |
| 7 | 2.3 | 22 | 0.92 | 4.8 | ∘ | 0.90(1.6) | 38 |
| 8 | 2.3 | 20 | 0.95 | 5 | ∘ | 0.95(1.7) | 35 |
| 9 | 1.5 | 10 | 0.9 | 5 | ∘ | 2.3(4.1) | 30 |
| 10 | 2.4 | 12 | 0.95 | 5.2 | ∘ | 1.0(1.77) | 23 |
| 11 | 2.4 | 10 | 0.98 | 5.3 | ∘ | 1.9(3.4) | 31 |
| 12 | 2 | 20 | 0.8 | 4.6 | ∘ | 0.2(0.35) | 60 |
| 13 | 2 | 20 | 0.75 | 4.6 | ∘ | 0.2(0.35) | 60 |
| comparative | | | | | | | |
| Example | | | | | | | |
| 1 | 2.4 | 15 | 0.93 | 4.6 | x | — | 14 |
| 2 | 1.5 | 14 | 0.9 | 4.5 | x | — | 14 |
| 3 | 1.9 | 20 | 0.85 | 4.4 | x | — | — |
| 4 | | 8 | | — | x | — | — |
| 5 | 1.5 | 9 | 0.9 | — | x | — | — |

### <Manufacturing Method of Electrode>

### <Positive Electrode>

Cell seed (Lithium cobaltate, manufactured by Nippon Chemical Industrial Co., Ltd.), SP270 (graphite, manufactured by Nippon Graphite Industry Co., LTD.), and KF1120 (polyvinylidene fluoride, manufactured by KUREHA CORPORATION) were mixed at a ratio of 85:10:10% by weight, then they were charged and mixed in N-methyl-2-pyrrolidone to prepare a slurry-like solution. An aluminum foil of 20 μm thickness was coated with the slurry by a doctor blade method and dried. The coating amount of the mixture was 100 g/m². The aluminum foil coated with the slurry and dried was pressed such that the mixture bulk density was 2.7 g/cm³ and the electrode was cut into a circular shape of 0.75 cm radius to manufacture a positive electrode.

### <Negative Electrode>

Negative electrodes of 1 and 2 below were used as the negative electrode.

1. Li metal (manufactured by Honjo Metal Co.)
2. Carbotron PE (amorphous carbon manufactured by Kureha Chemical Industry Co.) and KF1120 (polyvinylidene fluoride, manufactured by Kureha Chemical Industry Co.) were mixed at a ratio of 90:10% by weight and charged and mixed in N-methyl-2-pyrrolidone to prepare a slurry-like solution. A copper foil of 20 μm thickness was coated with the slurry by a doctor blade method and dried. The coating amount of the mixture was 40 g/m². The copper coated with the slurry and dried was pressed such that the mixture bulk density was 1.0 g/cm³, and the electrode was cut into a circular shape of 0.75 cm radius to manufacture a negative electrode.

### <Manufacturing Method of Battery>

A separator made of polyolefin was inserted between the positive electrode and negative electrode, to form an electrode group into which an electrolyte was poured. Then, by sealing the product with an aluminum laminate, a battery was manufactured.

### <Evaluation Method for Battery>

### 1. Initialization Method of Battery

The thus manufactured battery was charged to 4.3 V at a current density of 0.45 mA/cm², and then discharged until the discharged amount was reached 3 V. By repeating the cycle operation for 3 cycles, the battery was initialized. Further, the discharge capacity at the third cycle was defined as the battery capacity of the battery. Further, upon discharge at the third cycle, DC resistance (R) was determined based on the voltage drop (ΔE) at five seconds after starting of discharge and the current value (I) during discharge.

### 2. Cycle Test

The manufactured battery was charged to 4.3 V at a current density of 0.45 mA/cm², and then discharged until the discharged amount was reached 3 V. The charge/discharge cycles were repeated to conduct a cycle test. The cycle characteristic was evaluated by determining the ratio between the discharge capacity at the first cycle and the discharge capacity after 50 cycles.

### 3. Overcharge Test

The manufactured battery was preliminarily charged to 4.3 V at a current value with the current density of 0.45 mA/cm². Then, an overcharge test was conducted with 7 V being as an upper limit at a current value with the current density of 1.36 mA/cm². The amount of current supply during overcharge was defined as an overcharge amount.

The reaction initiation voltage of the overcharge suppressing agent of the invention was determined by comparing a charging curve of the battery not incorporated with the overcharge suppressing agent and a charging curve of the battery incorporated with the suppressing agent. The increasing rate of the overvoltage was determined by taking the difference of voltage (V) between the reaction initiation voltage and the upper limit voltage of the overcharge suppressing agent and the charging amount (mAh) required for the difference, and taking the ratio (V/mAh) thereof. Further, the value was converted per electrode unit area (cm²) (Vcm²/mAh) and normalized.

Further, when it did not reach the upper limit of 7 V, the overcharge test was conducted while defining 200% of the battery capacity as an upper limit.

After completing the overcharge test, the internal resistance of the battery was measured. In the measurement for the internal resistance, after the overcharged battery was once discharged until the discharged amount was reached 4.3 V, the battery was discharged for one minute at a current density of 0.45 mA/cm² and the DC resistance (R) was determined based on the voltage drop (ΔE) at 5 sec after the initiation of discharge and the current value (I) during discharge.

### Example 1

Molecular sieves were added to styrene [Z₁=vinyl group, X₁=none, A=C₆H₅, manufactured by Wako Pure Chemical Industries, Ltd.] and diethylene glycol monomethyl ether methacrylate [Z₂=methacryl group, Y═(CH₂CH₂O)₂CH₃, manufactured by Tokyo Chemical Industry Co., Ltd] as the starting monomers, and left it for one day and one night to remove the water content contained in the monomers. Then, the starting monomers were purified by distillation under a reduced pressure.

The purified styrene [75 mmol, 7.81 g] and diethylene glycol monomethyl ether methacrylate [25 mmol, 4.71 g] were mixed. Azobisisobutyronitrile (AIBN) was added as a polymerization initiator by 1 wt % of the entire monomers' weight and stirred till AIBN was dissolved. Then, the reaction solution was tightly sealed and reacted in an oil bath at 60° C. for 3 hours. After the completion of the reaction, the reaction solution was added to 200 mL methanol to obtain white precipitates. Then, the solution was filtered and dried under reduced pressure at 60° C. to obtain a white polymer (Polymer A).

The polymer A was added to an electrolyte (electrolyte salt: LiPF₆, solvent: EC/DMC/EMC=1:1:1 volume ratio, electrolyte salt solution: 1 mol/L, manufactured by TOYAMA CHEMICAL CO., LTD). The concentration of the polymer A was adjusted to 2 wt %. Hereinafter, the composition of the electrolyte containing the polymer A was defined as an electrolyte A.

A battery was manufactured by using the electrolyte A and the battery was evaluated for its characteristics. In this case, Li metal was used for the negative electrode. The manufactured battery had a battery capacity of 2.4 mAh, a DC resistance of 10Ω, and a cycle characteristic of 0.98.

A battery was manufactured separately under the same conditions and an overcharge test was conducted. The reaction voltage of the polymer A was 5.1 V and abrupt increase of the overvoltage was observed. The increasing rate was 2.0 (V/mAh). It was 3.5 (Vcm²/mAh) when converted to current density. The DC resistance after the overcharge test was 31Ω.

### Example 2

Investigation was conducted by the same method as in Example 1 except for changing the concentration of the polymer A to 5 wt %.

The manufactured battery had a battery capacity of 2.2 mAh, a DC resistance of 14Ω and a cycle characteristic of 0.95.

A battery was manufactured separately under the same conditions and an overcharge test was conducted. The reaction voltage of the polymer A was 5.1 V and abrupt increase of the overvoltage was observed. The increasing rate was 2.5 (V/mAh). It was 4.4 (Vcm²/mAh) when converted to the current density. The DC resistance after the overcharge test was 42Ω.

### Example 3

Investigation was conducted by the same method as in Example 1 except for changing the concentration of the polymer A to 10 wt %.

The manufactured battery had a battery capacity of 2.0 mAh, a DC resistance of 20Ω and a cycle characteristic of 0.95.

A battery was manufactured separately under the same conditions and an overcharge test was conducted. The reaction voltage of the polymer A was 5.1 V and abrupt increase of the overvoltage was observed. The increasing rate was 2.3 (V/mAh). It was 4.1 (Vcm²/mAh) when converted to the current density. The DC resistance after the overcharge test was 54Ω.

### Example 4

Investigation was conducted by the same method as in Example 1 except for changing the molar ratio of styrene and diethylene glycol monomethyl ethyl methacrylate to 0.05. Further, this polymer was defined as a polymer B.

The manufactured battery had a battery capacity of 2.4 mAh, a DC resistance of 13Ω and a cycle characteristic of 0.98.

A battery was manufactured separately under the same conditions and an overcharge test was conducted, but no abrupt increase of the overvoltage was observed.

### Example 5

Investigation was conducted by the same method as in Example 1 except for preparing a polymer by using only the ethylene glycol monomethyl ethyl methacrylate. Further, this polymer was defined as polymer B.

The manufactured battery had a battery capacity of 2.4 mAh, a DC resistance of 13Ω and a cycle characteristic of 0.98.

A battery was manufactured separately under the same conditions and an overcharge test was conducted, but no abrupt increase of the overvoltage was observed.

### Example 6

Molecular sieves were added to styrene [Z₁=vinyl group, X₁=none, A=C₆H₅, manufactured by Wako Pure Chemical Industries, Ltd.] and allyl alcohol [Z₂=vinyl group, Y═(CH₂CH₂OH), manufactured by Aldrich Corporation] as the starting monomers, and left it for one day and one night to remove the water content contained in the monomers. Then, the starting monomers were purified by distillation under a reduced pressure.

The purified styrene [40 mmol, 4.17 g] and allyl alcohol [60 mmol, 3.50 g] were mixed. Azobisisobutyronitrile (AIBN) was added as a polymerization initiator by 1 wt % of the entire monomers' weight and stirred till AIBN was dissolved. Then, the reaction solution was tightly sealed and reacted in an oil bath at 60° C. for 3 hours. After the completion of the reaction, the reaction solution was added to 200 mL methanol to obtain white precipitates. Then, the solution was filtered and dried under reduced pressure at 60° C. to obtain a white polymer (Polymer D).

The polymer D was added to an electrolyte (electrolyte salt: LiPF₆, solvent: EC/DMC/EMC=1:1:1 volume ratio, electrolyte salt solution: 1 mol/L, manufactured by TOYAMA CHEMICAL CO., LTD). The concentration of the polymer D was adjusted to 2 wt %. Hereinafter, the composition of the electrolyte containing the polymer D was defined as an electrolyte D.

A battery was manufactured by using the electrolyte D and the battery was evaluated for its characteristics. In this case, Li metal was used for the negative electrode.

The manufactured battery had a battery capacity of 2.3 mAh, a DC resistance of 26Ω, and a cycle characteristic of 0.90.

A battery was manufactured separately under the same conditions and an overcharge test was conducted. The reaction voltage of the polymer D was 5.1 V and abrupt increase of the overvoltage was observed. The increasing rate was 0.8 (V/mAh). It was 1.4 (Vcm²/mAh) when converted to the current density. The DC resistance after the overcharge test was 42Ω.

### Example 7

Investigation was conducted by the same method as in Example 6 except for changing the molar ratio of styrene and allyl alcohol to 0.75. Further, this polymer was defined as polymer E.

The manufactured battery had a battery capacity of 2.3 mAh, a DC resistance of 22Ω and a cycle characteristic of 0.92.

A battery was manufactured separately under the same conditions and an overcharge test was conducted. The reaction voltage of the polymer D was 5.1 V and abrupt increase of the overvoltage was observed. The increasing rate was 0.9 (V/mAh). It was 1.6 (Vcm²/mAh) when converted to the current density. The DC resistance after the overcharge test was 38Ω.

### Example 8

Molecular sieves were added to styrene [Z₁=vinyl group, X₁=none, A=C₆H₅, manufactured by Wako Pure Chemical Industries, Ltd.] and acrylonitrile [Z₂=vinyl group, Y═(CN), manufactured by Aldrich Corporation] as the starting monomers, and left it for one day and one night to remove the water content contained in the monomers. Then, the starting monomers were purified by distillation under a reduced pressure.

The purified styrene [75 mmol, 7.81 g] and acrylonitrile [25 mmol, 1.33 g] were mixed. Azobisisobutyronitrile (AIBN) was added as a polymerization initiator by 1 wt % of the entire monomers' weight and stirred till AIBN was dissolved. Then, the reaction solution was tightly sealed and reacted in an oil bath at 60° C. for 3 hours. After the completion of the reaction, the reaction solution was added to 200 mL methanol to obtain white precipitates. Then, the solution was filtered and dried under a reduced pressure at 60° C. to obtain a white polymer (Polymer F). The polymer F was added to an electrolyte (electrolyte salt: LiPF₆, solvent: EC/DMC/EMC=1:1:1 volume ratio, electrolyte salt solution: 1 mol/L, manufactured by TOYAMA CHEMICAL CO., LTD). The concentration of the polymer F was adjusted to 2 wt %. Hereinafter, the composition of the electrolyte containing the polymer F was defined as electrolyte F.

A battery was manufactured by using the electrolyte F and the battery was evaluated for its characteristics. In this case, Li metal was used for the negative electrode.

The manufactured battery had a battery capacity of 2.3 mAh, a DC resistance of 20Ω, and a cycle characteristic of 0.95.

A battery was manufactured separately under the same conditions and an overcharge test was conducted. The reaction voltage of the polymer F was 5.0 V and abrupt increase of the overvoltage was observed. The increasing rate was 0.95 (V/mAh). It was 1.7 (Vcm²/mAh) when converted to current density. The DC resistance after the overcharge test was 35Ω.

### Example 9

Investigation was conducted in the same manner as in Example 1 except for using amorphous carbon instead of Li metal for the negative electrode.

The manufactured battery had a battery capacity of 1.5 mAh, a DC resistance of 10Ω, and a cycle characteristic of 0.90.

A battery was manufactured separately under the same conditions and an overcharge test was conducted. When the battery voltage was 5.0 V or higher, abrupt increase of the overvoltage was observed. The increasing rate was 2.3 (V/mAh). It was 4.1 (Vcm²/mAh) when converted to the current density. The DC resistance after the overcharge test was 30Ω.

### Example 10

Investigation was conducted by the same method as in Example 1 except for manufacturing a polymer by using only styrene. This polymer was defined as a polymer G.

The manufactured battery had a battery capacity of 2.4 mAh, the DC resistance of 12Ω, and cycle characteristic of 0.95.

A battery was manufactured separately under the same conditions and an overcharge test was conducted. The reaction voltage of the polymer G was 5.2 V and abrupt increase in the overvoltage was observed.

### Example 11

Molecular sieves were added to phenyl methacrylate [Z₁=methacryl group, X₁=none, A=C₆H₅, manufactured by Aldrich Corporation] and diethylene glycol monomethyl ether methacrylate [Z₂=methacryl group, Y═(CH₂CH₂O)₂CH₃, manufactured by Tokyo Chemical Industry Co., Ltd] as the starting monomers, and left it for one day and one night to remove the water content contained in the monomer. Then, the starting monomers were purified by distillation under reduced pressure.

The purified phenyl methacrylate [75 mmol, 12.2 g] and diethylene glycol monomethyl ether methacrylate were mixed. Azobisisobutyronitrile (AIBN) was added as a polymerization initiator by 1 wt % of the entire monomers' weight and stirred till AIBN was dissolved. Then, the reaction solution was tightly sealed and reacted in an oil bath at 60° C. for 3 hours. After the completion of the reaction, the reaction solution was added to 200 mL methanol to obtain white precipitates. Then, the solution was filtered and dried under a reduced pressure at 60° C. to obtain a white polymer (Polymer H). The polymer H was added to an electrolyte (electrolyte salt: LiPF₆, solvent: EC/DMC/EMC=1:1:1 volume ratio, electrolyte salt solution: 1 mol/L, manufactured by TOYAMA CHEMICAL CO., LTD). The concentration of the polymer H was adjusted to 2 wt %. Hereinafter, the composition of the electrolyte containing the polymer H was defined as an electrolyte H.

A battery was manufactured by using the electrolyte H and the battery was evaluated for its characteristics. In this case, Li metal was used for the negative electrode.

The manufactured battery had a battery capacity of 2.4 mAh, a DC resistance of 10Ω, and a cycle characteristic of 0.98.

A battery was manufactured separately under the same conditions and an overcharge test was conducted. The reaction voltage of the polymer H was 5.3 V and abrupt increase of the overvoltage was observed. The increasing rate was 1.9 (V/mAh). It was 3.4 (Vcm²/mAh) when converted to the current density. The DC resistance after the overcharge test was 31Ω.

### Example 12

In Example 1, the monomers were placed in a battery without polymerization, and evaluation was conducted. The monomer was defined as a monomer composition A.

The manufactured battery had a battery capacity of 2.0 mAh, a DC resistance of 20Ω, and a cycle characteristic of 0.80.

A battery was manufactured separately under the same conditions and an overcharge test was conducted. When the battery voltage was 4.6 V or higher, abrupt increase in the overvoltage was observed. The increasing rate was 0.2 (V/mAh). It was 0.35 (Vcm²/mAh) when converted to current density. The DC resistance after the overcharge test was 60Ω.

### Example 13

In Example 10, the monomers were placed in a battery without polymerization, and evaluation was conducted. The monomer was defined as a monomer composition B.

The manufactured battery had a battery capacity of 2.0 mAh, a DC resistance of 20Ω, and a cycle characteristic of 0.75.

A battery was manufactured separately under the same conditions and an overcharge test was conducted. When the battery voltage was 4.6 V or higher, abrupt increase in the overvoltage was observed. The increasing rate was 0.2 (V/mAh). It was 0.35 (Vcm²/mAh) when converted to the current density. The DC resistance after the overcharge test was 60Ω.

### Comparative Example 1

Cyclohexyl benzene was added to an electrolyte (electrolyte salt: LiPF₆, solvent: EC/DMC/EMC=1:1:1 volume ratio, electrolyte salt solution: 1 mol/L, manufactured by TOYAMA CHEMICAL CO., LTD) such that the concentration of the cyclohexyl benzene was 2 wt %. A battery was manufactured by using the electrolyte and the battery was evaluated for its characteristics. In this case, Li metal was used for the negative electrode. In this case, Li metal was used for the negative electrode.

The manufactured battery had a battery capacity of 2.4 mAh, a DC resistance of 12Ω, and a cycle characteristic of 0.93.

A battery was manufactured separately under the same conditions and an overcharge test was conducted. When the battery voltage was 4.6 V or higher, reaction of cyclohexyl benzene was observed, but increase of the overvoltage was not observed.

### Comparative Example 2

Investigation was conducted in the same manner as in Comparative Example 1 except for using amorphous carbon instead of Li metal for the negative electrode. The manufactured battery had a battery capacity of 1.5 mAh, a DC resistance of 11Ω, and a cycle characteristic of 0.90.

A battery was manufactured separately under the same conditions and an overcharge test was conducted. When the battery voltage was 4.5 V or higher, reaction of cyclohexyl benzene was observed, but increase of the overvoltage was not observed.

### Comparative Example 3

Investigation was conducted in the same manner as in Comparative Example 1 except for using thiophene instead of cyclohexylbenzene.

The manufactured battery had a battery capacity of 1.9 Ah, a DC resistance of 20Ω, and a cycle characteristic of 0.85.

A battery was manufactured separately under the same conditions and an overcharge test was conducted. When the battery voltage was 4.4 V or higher, reaction of cyclohexyl benzene was observed, but increase of the overvoltage was not observed.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. A lithium ion secondary battery comprising;
a positive electrode, a negative electrode, and an electrolyte,
wherein the electrolyte contains a compound represented by formula Z₁-A (compound 1-1), Z₁-X-A (compound 1-2), or a polymer of compound 1-1 or compound 1-2,
in which Z₁ is a polymerizable functional group, X is a hydrocarbon group or an oxyalkylene group which has 1 or more and 20 or fewer carbon atoms, and A is an aromatic functional group.

2. The lithium ion secondary battery according to claim 1,
wherein a number average molecular weight (Mn) of the polymer is 1,000,000 or less.

3. The lithium ion secondary battery according to claim 1,
wherein the polymer is represented by the formula Zₚ₁-A (polymer 2-1) or the formula Zₚ₁-X-A (polymer 2-2),
in which Z_{P1} is an organic group formed by polymerizing a polymerizable functional group.

4. The lithium ion secondary battery according to claim 1,
wherein the electrolyte contains a compound 3 represented by the formula Z₂—Y,
in which Z₂ is a polymerizable functional group, Y is a functional group comprising at least one element selected from H, C, N, O, F, S, and Si,
wherein Y is a non-aromatic functional group.

5. The lithium ion secondary battery according to claim 1,
wherein the electrolyte contains a polymer made from compound 1-1 or compound 1-2 and compound 3 represented by the formula Z₂—Y,
in which Z₂ is a polymerizable functional group, Y is a functional group comprising at least one element selected from H, C, N, O, F, S,
wherein Y is a non-aromatic functional group.

6. The lithium ion secondary battery according to claim 5,
wherein the polymer contains unit represented by the chemical formula (4-1) or the chemical formula (4-2),
1) 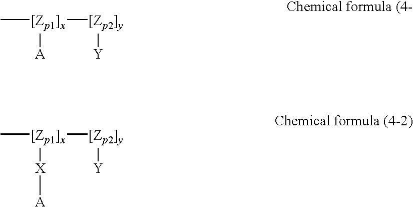
in which Zₚ₁ is an organic group formed by polymerizing polymerizable functional groups, Zₚ₂ is an organic group formed by polymerizing polymerizable functional groups, and x and y show the ratio of the constituent units for Z₁ and Z₂.

7. The lithium ion secondary battery according to claim 6,
wherein the chemical formula (4-1) or the chemical formula (4-2) satisfies a relation: 0.1≦x/(x+y) 0.9.

8. The lithium ion secondary battery according to claim 6,
wherein the polymer is represented by the chemical formula (5), 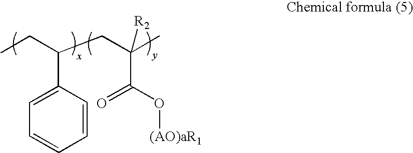
in which AO is an oxyalkylene group having 1 or more and 4 or fewer carbon atoms, a is a number for the oxyalkylene group, each of and R₁ and R₂ is H or a hydrocarbon group having 1 or more and 20 or fewer carbon atoms.

9. The lithium ion secondary battery according to claim 1,
wherein the polymerizable compound is polymerized at 2.0 V or higher on the basis of Li/Li+.

10. The lithium ion secondary battery according to claim 1,
wherein the polymerizable compound is polymerized at 4.5 V or higher on the basis of Li/Li+.

11. The lithium ion secondary battery according to claim 1,
wherein the increasing rate of an overpotential at a potential of about 5.1 V is 0.2 Vcm²/mAh or higher.
